(19) United States
(12) Patent Application Publication
(10) Pub. No.: US 2026/0084603 A1
(43) Pub. Date: Mar. 26, 2026

(54) FOLDABLE TABLE BOARD, FURNITURE, AND VEHICLE

(71) Applicants: INTEVA PRODUCTS ZHENJIANG CO. LTD., Zhenjiang (CN); INTEVA PRODUCTS EUROPE GMBH, Solingen (DE)

(72) Inventors: Liang Yiren, Pudong (CN); Gou Yang, Zhenjiang (CN)

(21) Appl. No.: 19/333,992

(22) Filed: Sep. 19, 2025

(30) Foreign Application Priority Data
Sep. 20, 2024 (CN) 202411323365.8
Sep. 20, 2024 (CN) 202422305815.2

(51) Int. Cl. B60N 3/00; A47B 3/00; A47B 11/00

(52) U.S. Cl. CPC B60N 3/001; A47B 3/00; A47B 11/00

(57) ABSTRACT

A foldable table board, a furniture, and a vehicle are provided in the embodiments of the application. The foldable table board includes a table board mechanism and a base. The table board mechanism includes a supporting assembly and a table board arranged on the supporting assembly. The table board is movably connected with the supporting assembly to switch the table board between a folding state and an unfolding state relative to the supporting assembly. The base 1 is configured for carrying the table board mechanism, and the supporting assembly is rotatably connected with the base to rotate the table board between a first position and a second position relative to the base. The supporting assembly is rotatably connected with the base, and the position of the table board can be adjusted by rotating the supporting assembly. Thus, the position of the table board can be adjusted according to the actual position of the user, which is convenient for the user to use the table board. Since the table board can be rotated along with the supporting assembly to adjust the position thereof, the single table board can meet the use requirements when the user is in different positions. Therefore, the foldable table board can be provided with only one table board, the volume of the foldable table board can be reduced, thereby reducing the space occupied by the foldable table board.

### CROSS REFERENCE TO RELATED APPLICATIONS

This application claims priority under 35 U.S.C. § 119 to the following Chinese Patent Application No. 202411323365.8, filed on Sep. 20, 2024, and Chinese Utility Model patent application No. 202422305815.2, filed on Sep. 20, 2024, the entire contents each of which are incorporated herein by reference thereto.

### TECHNICAL FIELD

The present application relates to the field of vehicle accessories, in particularly to a foldable table board, a furniture, and a vehicle.

### BACKGROUND

Vehicles such as automobiles are commonly used for traveling, and various convenience devices are usually installed in the vehicles to provide convenience for drivers and passengers. For example, a table board is arranged in the middle of the rear seats of some automobiles to facilitate users to work or have entertainment activities in the automobile. In order to reduce the occupation of the table board to the space in the automobile, the table board is usually a foldable table board, and the foldable table board has a storage form after being folded and a use form after being unfolded, and the table board can be folded and stored when the table board is not needed.

In the existing art, some vehicles are respectively provided with a left table board and a right table board in the middle of the rear seats, so that the user can comfortably use the table board when sitting on the left seat or the right seat.

However, an increase in the number of the table boards takes up the space in the automobile, resulting in a crowded space in the automobile.

### SUMMARY

A foldable table board, a furniture, and a vehicle are provided to solve the technical problem that the foldable table board occupies too much space in the automobile, leading to a crowded space in the automobile.

Embodiments of the present application adopt the following technical solutions:

In a first aspect, a foldable table board is provided. The foldable table board includes: a table board mechanism, and a base for carrying the table board mechanism. The table board mechanism includes: a supporting assembly, and a table board arranged on the supporting assembly. The table board is movably connected to the supporting assembly, so that the table board is switched between a folded state and an unfolded state relative to the supporting assembly. The supporting assembly is rotatably connected to the base, so that the table board can rotate between a first position and a second position relative to the base.

In some embodiments, the foldable table board further includes: a first driving mechanism mounted to the base. The first driving mechanism is drivingly connected to the supporting assembly to drive the supporting assembly to rotate relative to the base, thereby driving the table board to rotate to the first position or the second position.

In some embodiments, the first driving mechanism includes: a first driving member, and a first transmission assembly connected with the first driving member. One of the first driving member and the first transmission assembly is mounted to the base. The other of the first driving member and the first transmission assembly is connected with the supporting assembly. The first transmission assembly is configured for adjusting a rotating speed of the supporting assembly relative to the base.

In some embodiments, the first transmission assembly includes: a worm gear, and a worm engaged and connected with the worm gear. The worm is connected with an output shaft of the first driving member, and the worm gear being connected with the supporting assembly.

Alternatively, the first transmission assembly includes a first gear and an internal gear. The first gear is engaged with gear teeth arranged on an inner peripheral side surface of the internal gear. The first gear is connected with an output shaft of the first driving member. The internal gear is connected with the base.

Alternatively, the first transmission assembly includes a second gear and a third gear. The second gear is engaged with gear teeth arranged on an outer peripheral side surface of the third gear. The second gear is connected with an output shaft of the first driving member. The third gear is connected with the supporting assembly.

In some embodiments, the supporting assembly includes: a rotating component rotatably mounted to the base, and a supporting component arranged on the rotating component. The table board is arranged on the supporting component, and the rotating component is capable of rotating relative to the base to drive the supporting component to rotate, so that the table board rotates between the first position and the second position.

In some embodiments, the base is provided with a first limit component and a second limit component, and the rotating component is provided with a third limit component. When the table board is in the first position, the third limit component abuts against the first limit component. When the table board is in the second position, the third limit component abuts against the second limit component.

In some embodiments, the base is provided with a limit groove. The limit groove is arranged around a rotation axis of the rotating component. The third limit component is slidingly arranged in the limit groove. And the inner side walls at two ends of the limit groove in the length direction respectively form the first limit component and the second limit component.

In some embodiments, the base is provided with a first locking component and a second locking component, and the rotating component is provided with a third locking component. When the table board is in the first position, the first locking component is capable of being connected with the third locking component to limit the rotation of the rotating component. When the table board is in the second position, the second locking component is capable of being connected with the third locking component to limit the rotation of the rotating component.

In some embodiments, the table board mechanism further includes a second driving mechanism for driving the table board to switch between the folded state and the unfolded state. The second driving mechanism is connected with the table board and the third locking component respectively. When the second driving mechanism drives the table board to switch from the folded state to the unfolded state, the third locking component is synchronously driven by the second driving mechanism to move so that the third locking component is connected with the first locking component or the second locking component.

In some embodiments, the first locking component and the second locking component are locking holes provided in the base, and the third locking component is a locking pin slidingly arranged on the rotating component. When the locking pin is in an unlocking state, the locking pin is inserted into one of the locking holes. When the locking pin is in a locking state, the locking pin is separated from the locking holes.

In some embodiments, the locking pin includes: a connecting component connected with the supporting assembly, and a fastening component for inserting into the locking holes. The connecting component is arranged on a side of the rotating component away from the base. The rotating component is provided with a through hole. The fastening component is capable of being inserted into the locking holes through the through hole.

In some embodiments, the connecting component and the fastening component are spaced apart when the locking pin is in the unlocking state. The connecting component moves towards the fastening component and pushes the fastening component to be inserted into the locking holes when the locking pin is switched from the unlocking state to the locking state.

In some embodiments, one of the connecting component and the fastening component is provided with a locating member, the other of the connecting component and the fastening component is provided with a locating hole. The locating member is inserted into the locating hole when the connecting component abuts against the fastening component.

In some embodiments, the supporting assembly is further provided with an elastic member. The elastic member is connected with the fastening component and the rotating component respectively. The elastic member drives the fastening component to be separated from the locking holes when the locking pin is switched from the locking state to the unlocking state.

In some embodiments, the supporting assembly is further provided with a guiding component. The guiding component is connected with the locking pin and configured for guiding the movement of the locking pin.

In some embodiments, the second driving mechanism includes a second driving member and a second transmission assembly. The second transmission assembly includes: a screw rod connected with an output shaft of the second driving member, and a moving block slidingly arranged on the supporting assembly. The moving block is in threaded connection with the screw rod, and the third locking component is connected with the moving block.

In some embodiments, the supporting component includes a shell connected with the rotating component, and a part of the third locking component is located in an enclosed area of the shell and the rotating component.

In some embodiments, one of the base and the rotating component is provided with a first slide rail, and the other of the base and the rotating component is provided with a sliding block. The first slide rail is arranged around a rotation axis of the rotating component. The rotating component is rotated relative to the base by means of the sliding block slidably engaged with the first slide rail.

In some embodiments, the sliding block is annular. Alternatively, the sliding block is one of a plurality of sliding blocks, and the plurality of the sliding blocks are arranged at intervals around the rotation axis of the rotating component.

In some embodiments, the base is provided with an annular surrounding wall, and the annular surrounding wall is arranged around an edge of the rotating component.

In some embodiments, an inner side wall of the annular surrounding wall is provided with a fourth limit component. The fourth limit component is configured for abutting against a side of the rotating component away from the base.

In a second aspect, a furniture is provided. The furniture includes a first body and the foldable table board mention above. A first accommodating cavity is arranged in the first body component. The base of the foldable table board is connected with the first body component. The table board mechanism is fold and accommodated in the first accommodating cavity.

In a third aspect, a vehicle is provided. The vehicle includes a second component part and the foldable table board mention above. A second accommodating cavity is arranged in the second body component. The base of the foldable table board is connected with the second body component. The table board mechanism is fold and accommodated in the second accommodating cavity.

The foldable table board provided in the embodiments of the present application has the beneficial effects as follows:

The supporting assembly is rotatably connected with the base, so that the table board can be switched between the first position and the second position. The position of the table board can be converted according to the position of the user. Thus, the position of the table board can be adjusted according to the actual position of the user, which is convenient for the user to use the table board. Since the table board can be rotated along with the supporting assembly to adjust the position thereof, the single table board can meet the use requirements when the user is in different positions. Therefore, the foldable table board can be provided with only one table board, the volume of the foldable table board can be reduced, thereby reducing the space occupied by the foldable table board, reducing the congestion degree of the surrounding environment, and making the surrounding environment more spacious.

### BRIEF DESCRIPTION OF DRAWINGS

In order to clearly illustrate the technical solutions in embodiments of the present application, the following briefly describes the drawings required for describing the embodiments or the existing art. Obviously, the drawings in the followings description are merely some embodiments of this application. For those of ordinary skill in the art, other drawings may be obtained based on these accompanying drawings without creative efforts.

FIG. 1 is a schematic diagram of a state of a foldable table board provided by an embodiment of the present application;

FIG. 2 is a schematic diagram of another state of the foldable table board shown in FIG. 1;

FIG. 3 is a schematic diagram of an assembly structure of a base, a rotating component, and a supporting component provided by an embodiment of the present application;

FIG. 4 is a schematic diagram of the motion sequence of stowing the foldable table board shown in FIG. 1;

FIG. 5 is a schematic diagram of an assembly structure of a base, a rotating component, and a driving mechanism provided by an embodiment of the present application;

FIG. 6 is a schematic diagram of section view of the structure shown in FIG. 5;

FIG. 7 is a schematic diagram of an assembly structure of a base, a rotating component and a first driving mechanism provided by another embodiment of the present application;

FIG. 8 is a schematic diagram of the base shown in FIG. 5;

FIG. 9 is a schematic diagram of section view of the structure shown in FIG. 3;

FIG. 10 is a schematic diagram of a locking pin provided by an embodiment of the present application;

FIG. 11 is a schematic diagram of a rotating component provided by an embodiment of the present application;

FIG. 12 is a schematic diagram of a locking pin and a shell provided by an embodiment of the present application; and

FIG. 13 is a schematic diagram of a rotating component and a supporting component provided by an embodiment of the present application (a shell cover is not shown).

In the drawings, reference numerals are as follows:
S1, first axis; S2, second axis; S3, third axis; S4, fourth axis; S5, fifth axis;
1. base; 11, first board; 111, first slide rail; 112, first locking component; 113, second locking component; 114, first avoiding hole; 12, annular surrounding wall; 121, fourth limit component; 13, second board; 14, connecting shaft; 15, limit groove; 151, first limit component; 152, second limit component; 16, first connecting member;
2. supporting assembly; 21, rotating component; 211, sliding block; 212, third locking component; 2121, connecting component; 2122, fastening component; 2123, locating member; 2124, locating hole; 213, mounting column; 214, third limit component; 215, through hole; 22, supporting component; 221, guiding component; 2211, second slot; 2212, second slide rail; 222, shell; 2221, shell case; 2222, shell board; 223, push board; 23, elastic member;
3. table board; 31, board body; 32, arm body;
4. first driving mechanism; 41, first driving member; 421, first gear; 422, internal gear; 423, worm gear;
5. second driving mechanism; 51, second driving member; 521, screw rod; 522, moving block; 53, third driving member; and 54, sector gear.

### DETAILED DESCRIPTION

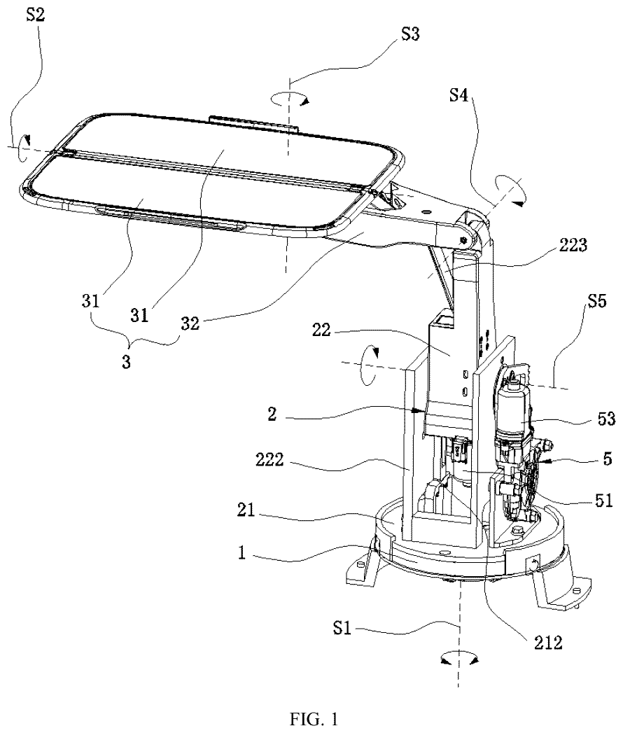

In order to make the technical problems, technical schemes and beneficial effects of the present application clearer, embodiments of the present application is further described in detail below in combination with the FIGS. 1 to 13 and examples. It should be understood that the specific embodiments described herein are merely illustrative of the present application and are not intended to limit the present application.

It should be noted that when an element is referred to as being “fixed to” or “arranged to, on, or around” another element, the element can be directly “fixed to” or “arranged to, on, or around” another element or indirectly “fixed to” or “arranged to, on, or around” another element. When an element is referred to as being “connected” to/with another element, it can be directly connected to/with the other element or indirectly connected to/with the other element.

It should be understood that the orientation or positional relationship indicated by the terms “length”, “width”, “upper”, “lower”, “front”, “rear”, “left”, “right”, “vertical”, “horizontal”, “top”, “bottom”, “inner”, “outer”, or etc. are based on the orientation or positional relationship shown in the drawings. The orientation or positional relationship indicated by the terms are merely for the convenience of describing the present application and simplifying the description, rather than indicating or implying that the apparatus or element referred to must have a specific orientation, be constructed and operated in a specific orientation. Therefore, the orientation or positional relationship indicated by the terms cannot be understood as a limitation to the present application.

In addition, the terms “first”, “second”, etc. are used herein for descriptive purposes and can not be understood as indicating or implying relative importance or implicitly indicating the number of indicated technical features. Therefore, the features defined with “first”, “second” can explicitly or implicitly include one or more of the features. In the description of the present application, the meaning of “a plurality of” is two or more, unless otherwise specifically defined.

Vehicles such as automobiles are commonly used for traveling, and various convenience devices are usually installed in the vehicles to provide convenience for drivers and passengers. For example, a table board is arranged in the middle of the rear seats of some automobiles to facilitate users to work or have entertainment activities in the automobile.

In order to reduce the occupation of the table board to the space in the automobile, the table board is usually a foldable table board, and the foldable table board has a storage form after being folded and a use form after being unfolded, and the table board can be folded and stored when the table board is not needed.

For some ordinary automobiles, only one table board is usually arranged in the automobile, and the table board is usually arranged in the middle of the rear seats, thus the user needs to use the table board by turning the user's body no matter the user sits on the left seat or the right seat, and the user's waist is prone to fatigue. In the existing art, to improve the user's comfort, two foldable table boards are arranged. The two foldable table boards are a left table board and a right table board. The left table board can be unfolded and used when the user sits on the left seat, and the right table board can be unfolded and used when the user sits on the right seat. The arrangement of the left table board and the right table board can enable the user to use the table board without turning the body, and reduce the fatigue of the user's waist.

For the foldable table board, the table board needs to be unfolded before use and to be folded and stored after use. This process consumes a lot of time and energy of the user, thus the table board is inconvenient to be used. Therefore, in the existing art, an electric driving member is arranged for the table board, and the electric driving member is configured to drive the folding and unfolding of the table board instead of manpower. For example, when the user sits on the left seat in the rear row, the left electric driving member can drive the left table board to unfold, and when the user sits on the right seat in the rear row, the right electric driving member can drive the right table board to unfold.

However, the addition of the electric driving member increases the overall size of each foldable table board, and especially for the automobile with two or more foldable table boards. The two or more foldable table boards excessively occupy the space in the automobile, leading to a crowded space in the automobile.

Based on this, a foldable table board, a furniture, and a vehicle are provided in the embodiments of the application to solve the technical problem in the existing art that the foldable table board excessively occupies the space in the automobile, leading to a crowded space in the automobile.

Referring to FIGS. 1 to 3, the foldable table board provided in the embodiments of the application is described.

The foldable table board provided in the embodiments of the application includes a table board mechanism and a base 1. The table board mechanism includes a supporting assembly 2 and a table board 3 arranged on the supporting assembly 2. The table board 3 is movably connected with the supporting assembly 2 to switch the table board 3 between a folding state and an unfolding state relative to the supporting assembly 2. The base 1 is configured for carrying the table board mechanism. The supporting assembly 2 is rotatably connected with the base 1 to rotate the table board 3 between a first position and a second position relative to the base 1.

Referring to FIG. 1, the supporting assembly 2 may rotate around a first axis S1, so that the supporting assembly 2 can relatively rotate between the supporting assembly 2 and the base 1.

It should be noted that the base 1 may be connected with an external fixing component to play a role of fixing and supporting. For example, when the foldable table board is applied to a seat, the base 1 can be connected with a body component of the seat to support the table board mechanism. For another example, when the foldable table board is applied to a tea table, the base 1 can be connected with a body component of the tea table.

It should be noted that the application field of the foldable table board is not limited to the above example scenarios, and the foldable table board can also be used in combination with some floor lamps. The foldable table board can be applied in the field of vehicles, for example, the folded table board can be stored in an armrest box of a seat of a vehicle, or the base is connected with an inner wall of a carriage, and the folded table board can be stored in a cavity of the inner wall of the carriage, and the like. The foldable table board can be applied in the field of furniture, for example, be applied in a sofa, a bedside table, or a floor lamp, and the like. The foldable table board can be applied outdoors, for example, a leisure area in a park, an outdoor construction frame, and the like. And the application field of the foldable table board is not limited in the embodiments of the application.

It should be noted that when the table board 3 is in the folded state, that is, the table board 3 is not being used, the folded table board occupies the smallest space, and the folded table board can be stored in a certain space. It should be noted that when the table board 3 is in the unfolded state, the table board 3 of the foldable table board can form a bearing surface for a user to use. For example, the user can place a computer, a mobile phone, and the like on the table board 3.

It should be noted that in some embodiments, a rotation angle between the first position and the second position can be 180°, 190°, 170°, 90°, etc. The table board 3 in the first position and the second position may be respectively located on the left side and the right side of the base 1. In other embodiments, the table board 3 in the first position and the second position can be respectively located on the front side and the rear side of the base 1. In other embodiments, the table board 3 in the first position and the second position can be respectively located on the left side and the front side of the base 1.

The supporting assembly 2 is rotatably connected with the base 1, so that the table board 3 can be switched between the first position and the second position, thereby switching the position of the table board 3 according to the position of the user. For example, when the user is located on the left side of the base 1, the table board 3 can be rotated to the left side of the base 1 by the supporting assembly 2. And correspondingly, when the user is located on the right side of the base 1, the table board 3 can be rotated to the right side of the base 1 by the supporting assembly 2. Thus the position of the table board 3 can be adjusted according to the actual position of the user, and the user can conveniently use the table board 3. Since the table board 3 can be rotated along with the supporting assembly 2 to adjust the position thereof, the single table board 3 can meet the use requirements when the user is in different positions. Therefore, the foldable table board 3 can be provided with only one table board, the volume of the foldable table board can be reduced, thereby reducing the space occupied by the foldable table board, reducing the congestion degree of the surrounding environment, and making the surrounding environment more spacious.

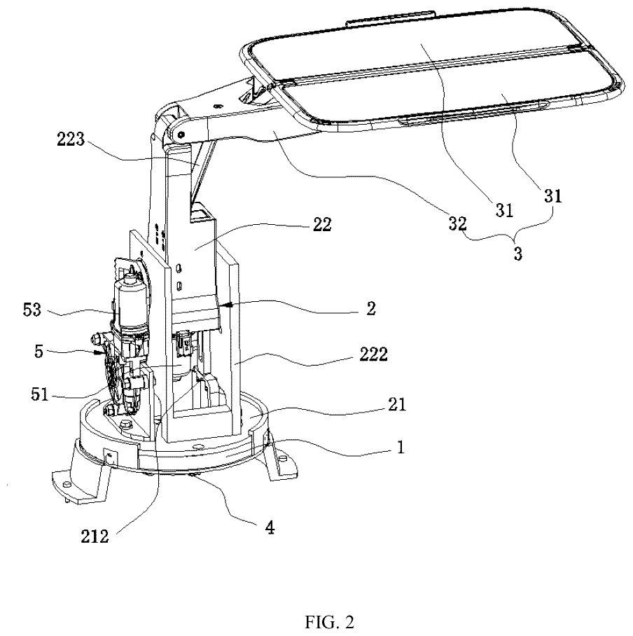

In some embodiments, the foldable table board can be applied to a rear seat of a automobile, and the foldable table board is arranged in the middle of the rear seat. When a user sits on the left seat, the table board mechanism can be arranged in the unfolded state and located at the first position (referring to FIG. 1). When the user sits on the right seat, the table board mechanism at the first position can be rotated by 180° around the first axis S1 to be located at the second position (referring to FIG. 2).

The foldable table board also includes a first driving mechanism 4 mounted to the base 1. The first driving mechanism 4 is drivingly connected to the supporting assembly 2 to drive the supporting assembly 2 to rotate relative to the base 1, thereby driving the table board 3 to rotate to the first position or the second position. The first driving mechanism 4 can drive the supporting assembly 2 to rotate to drive the table board 3 to rotate, so that the table board 3 can automatically switch between the first position and the second position. Therefore, the position of the table board 3 can be adjusted without manually operating the foldable table board, thus the difficulty of using the foldable table board is reduced, and the convenience of using the foldable table board is improved.

In this embodiment, the driving force of the first driving mechanism 4 acts on the supporting assembly 2, and the supporting assembly 2 rotates under the driving force to drive the table board 3 to rotate. That is, the driving force of the first driving mechanism 4 does not directly act on the table board 3. Therefore, the first driving mechanism 4 can be arranged away from the table board 3. In this way, when the table board 3 is unfolded, the space occupied by the first driving mechanism 4 can be reduced. For example, when the foldable table board is applied to a seat, the first driving mechanism 4 can be always accommodated in the body component of the seat. When the table board 3 is in the unfolded state or the folded state, the position of the first driving mechanism 4 does not change. The first driving mechanism 4 is not exposed to the external environment due to the unfolding of the table board 3. Therefore, the occupation of the environmental space by the first driving mechanism 4 can be reduced.

It should be noted that either the unfolding of the table board 3 or when the table board 3 is unfolding includes the process of unfolding the table board 3 and the period when the table board 3 is kept in the unfolded state. The table board 3 of the foldable table board shown in FIG. 1 is in the unfolded state.

In some embodiments, the table board 3 is switched between the unfolded state and the folded state by electric driving. Therefore, the foldable table board can be further conveniently used by the user.

In some embodiments, the first driving mechanism 4 includes a first driving member 41 and a first transmission assembly connected with the first driving member 41. One of the first driving member 41 and the first transmission assembly is connected with the base 1, and the other of the first driving member 41 and the first transmission assembly is connected with the supporting assembly 2. The first driving member 41 and the first transmission assembly are connected, and the first driving member 41 can be connected with the base 1 or the supporting assembly 2 through the first transmission assembly. The first transmission assembly can adjust the driving force direction of the first driving member 41, thereby facilitating the installation of the first driving member 41, saving the space that the foldable table board occupies to reduce the volume of the foldable table board. The first transmission assembly can adjust the rotating speed of the supporting assembly 2, so that the rotating speed of the supporting assembly 2 can be controlled to be within a proper range, and the stability of the rotation of the supporting assembly 2 is improved. In addition, the first transmission assembly can also change the driving force direction, thereby facilitating the design of the installation position of the first driving member 41, and saving the space occupied by the foldable table board.

In some embodiments, the first driving member 41 may be a motor.

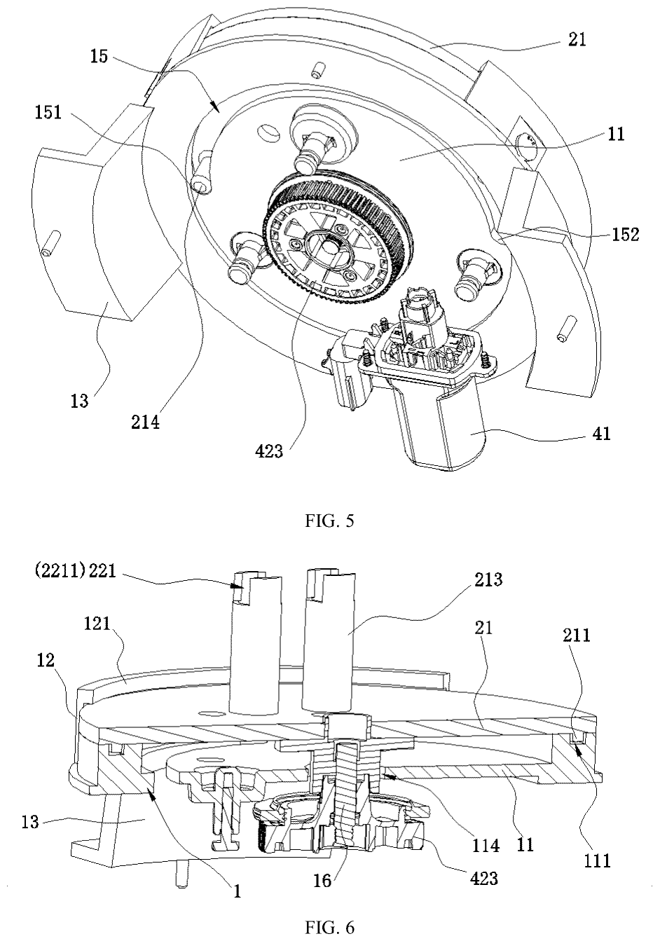

Referring to FIG. 5, in some embodiments, the first transmission assembly includes a worm gear 423 and a worm (not shown) engaged with the worm gear 423, the worm is connected with an output shaft of the first driving member 41, and the worm gear 423 is connected with the supporting assembly 2. The combination of the worm gear 423 and the worm can have a large transmission ratio, and have a compact structure, so that the size of the first transmission assembly can be reduced. Between the meshing tooth flanks of the worm gear 423 and the worm exists line contact, which has a large bearing capacity, thereby helping to improve the stability of the first transmission assembly. A worm drive is essentially a screw drive. The worm and the worm gear 423 are in multi-tooth meshing transmission relationship, so that the transmission relationship between the worm and the worm gear 423 is stable, and the worm drive is low-noise. The worm gear 423 and the worm have a self-locking characteristic. When the lead angle of the worm is less than the equivalent friction angle between the meshing gear teeth, only the worm can drive the worm gear 423, and the worm gear 423 cannot drive the worm. Thereby, the first driving member 41 can be safely protected. In this embodiment, the first driving member 41 can be arranged on the base 1.

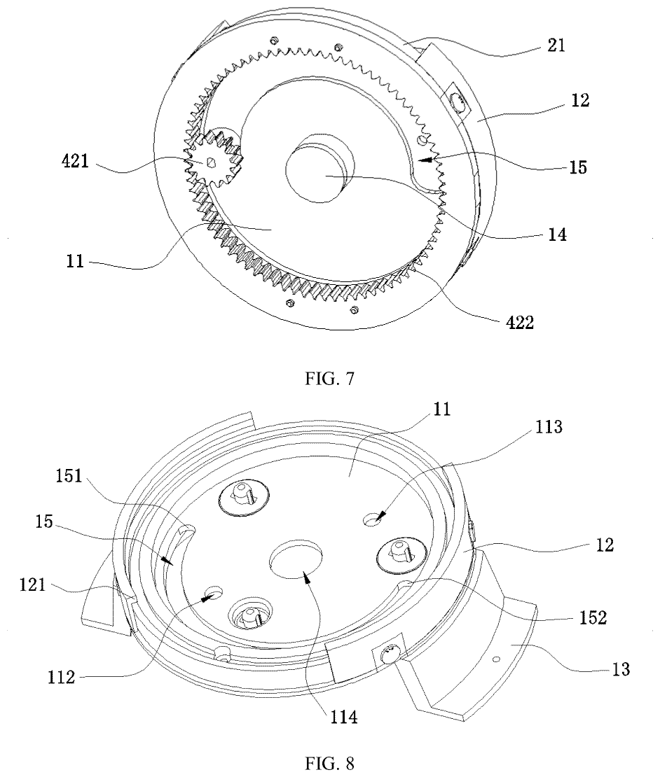

Referring to FIG. 7, in other embodiments, the first transmission assembly includes a first gear 421 and an internal gear 422, the first gear 421 is engaged with gear teeth arranged on the inner peripheral side surface of the internal gear 422, the first gear 421 is connected with the output shaft of the first driving member 41, and the internal gear 422 is connected with the base 1. The first transmission assembly provided with the internal gear 422 and the first gear 421 has a high reduction ratio and low vibration, and can enable the table board mechanism to rotate stably.

In some other embodiments, the first transmission assembly includes a second gear (not shown) and a third gear (not shown), the second gear is engaged with gear teeth arranged on the outer peripheral side surface of the third gear, the second gear is connected with the output shaft of the first driving member 41, and the third gear is connected with the supporting assembly 2. In this embodiment, the first driving member 41 may be arranged on the base 1 or the supporting assembly 2, and the connection mode of the third gear and the supporting assembly 2 can refer to the above embodiments; and the second gear and the third gear can be spur gears or bevel gears.

In some embodiments, the supporting assembly 2 includes a rotating component 21 rotatably mounted to the base 1 and a supporting component 22 arranged on the rotating component 21. The table board 3 is arranged on the supporting component 22, the rotating component 21 is capable of rotating relative to the base 1, thereby driving the supporting component 22 to rotate so that the table board 3 switches between the first position and the second position. Referring to FIG. 1, the table board 3 is in the unfolded state and is in the first position. Referring to FIG. 2, the table board 3 is in the unfolded state and is in the second position. The table board 3 can rotate 180° about the first axis S1 from the first position to the second position. The supporting component 22 is arranged on the rotating component 21. The rotating component 21 can be regarded as an extension structure of the supporting component 22. In this way, the connection between the supporting assembly 2 and the base 1 is facilitated, the connection stability between the supporting assembly 2 and the base 1 is improved, and the stability of the table board 3 during use is improved.

For example, the base 1 may be provided with a first board 11, the rotating component 21 may be constructed as a board structure, and the rotating component 21 may be rotatably mounted to the first board 11.

For example, the first driving mechanism 4 may be connected with the rotating component 21 and the first board 11 respectively.

Referring to FIG. 6, in some embodiments, the first transmission assembly includes a worm gear 423 and a worm (not shown in the figure) engaged with the worm gear 423. The worm gear 423 is arranged on a side of the first board 11 away from the rotating component 21. A first avoiding hole 114 may be formed in the center of the first board 11, and the worm gear 423 can be connected with the rotating component 21 by using a first connecting member 16 to penetrate through the first avoiding hole 114.

Referring to FIG. 7, in some embodiments, the first transmission assembly includes a first gear 421 and an internal gear 422 engaged with the first gear 421. The first driving piece 41 can be arranged on the supporting assembly 2. The center of the rotating part 21 and the center of the first plate 11 may be rotatably connected using a connecting shaft 14. The internal gear 422 and the first gear 421 can be arranged on a side of the first board 11 towards the rotating component 21. The internal gear 422 and the first gear 421 illustrated in FIG. 7 are arranged on a side of the first board 11 away from the rotating component 21, a second avoiding hole may be arranged in the first board 11, and the first gear 421 can be connected with the rotating component 21 by using a second connecting member to penetrate through the second avoiding hole.

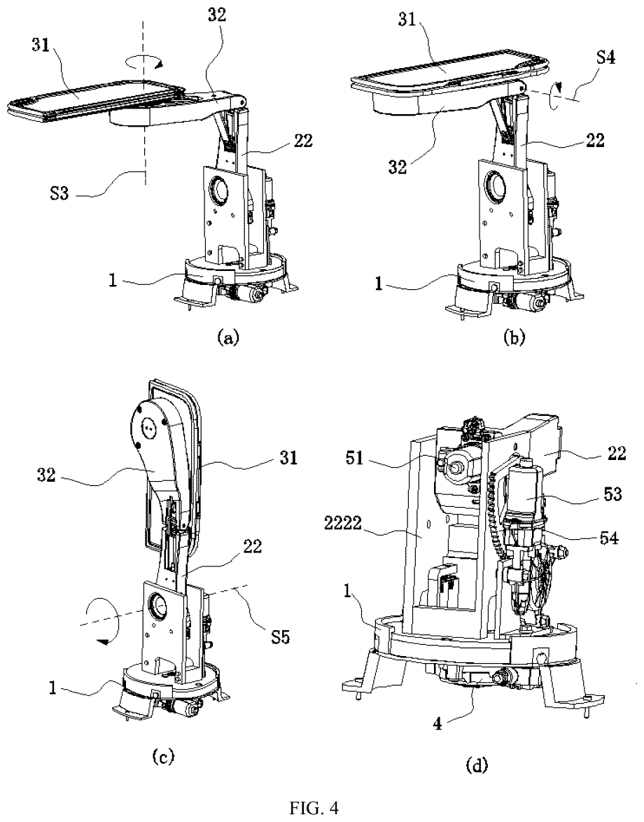

Referring to FIG. 1, the table board 3 includes two rotatably connected board bodies 31 and an arm body 32 connecting the two board bodies 31 with the supporting component 22. When the table board 3 is in the unfolded state, the two board bodies 31 may be unfolded as shown in FIG. 1, and the arm body 32 and the supporting component 22 can be vertically arranged. When it is necessary to fold the foldable table board, the board body 31 may be rotated around the second axis S2 shown in FIG. 1, so that the two board bodies 31 are superposed to form the state shown in part (a) of FIG. 4. The two superposed board bodies 31 may be rotated around the third axis S3 shown in part (a) of FIG. 4 to form the state shown in part (b) of FIG. 4. The arm body 32 may be flipped upward around the fourth axis S4 shown in part (b) of FIG. 4 to form the state shown in part (c) of FIG. 4. In part (c) of FIG. 4, the table board 3 is in the folded state, the supporting component 22 may be rotated around the fifth axis S5 shown in part (c) of FIG. 4 to form the state shown in part (d) of FIG. 4. The table board 3 is not shown in part (d) of FIG. 4.

It should be noted that the rotation of the board body 31, the arm body 32 and the supporting component 22 shown in FIG. 4 may be performed sequentially or simultaneously.

Referring to FIGS. 5 and 7, the base 1 is provided with a first limit component 151 and a second limit component 152, and the rotating component 21 is provided with a third limit component 214. When the table board 3 is in the first position, the third limit component 214 abuts against the first limit component 151. When the table board 3 is in the second position, the third limit component 214 abuts against the second limit component 152. The first limit component 151 and the second limit component 152 on the base 1 are used in cooperation with the third limit component 214 on the rotating component 21. The rotation angle of the rotating component 21 can be limited in a manner that surface contact forms a rotation barrier. The possibility of position deviation of the table board 3 caused by an excessively large rotation angle of the rotating component 21 can be reduced. In this way, the distance between the table board 3 and the user can be ensured, and the comfort during use of the table board 3 can be ensured.

For example, the first limit component 151 and the second limit component 152 can be arranged on the first board 11 of the base 1.

With reference to FIGS. 5 and 7, in some embodiments, the base 1 is provided with a limit groove 15. The limit groove 15 is arranged around the rotation axis of the rotating component 21. The third limit component 214 is slidingly arranged in the limit groove 15. The inner side walls of the two ends of the limit groove 15 along the length direction respectively form the first limit component 151 and the second limit component 152. The third limit component 214 is inserted into the limit groove 15 to realize the sliding connection of the third limit component 214 and the limit groove 15. Thus, the assembly difficulty of the rotating component 21 and the base 1 can be reduced, and the assembly efficiency of the foldable table board can be improved.

For example, the limit groove 15 may be arranged on the first board 11 of the base 1. It should be noted that the bottom of the limit groove 15 may penetrate through a side surface of the first board 11 away from the rotating component 21, or may not penetrate through a side surface of the first board 11 away from the rotating component 21. FIGS. 5 and 7 show that the limit groove 15 penetrates through a side surface of the first board 11 away from the rotating component 21.

For example, the rotation angle of the table board 3 is 180°. Thus the central angle corresponding to the arc-shaped limit groove 15 may be set to 180°.

Referring to FIG. 7, the third limit component 214 may also serve as a second connecting member for connecting the first gear 421 and the rotating component 21 in the above embodiments. The limit groove 15 may also serve as a second avoiding hole for avoiding the second connecting member in the above embodiments. The bottom of the limit groove 15 penetrates through a side surface of the first board 11 away from the rotating component 21.

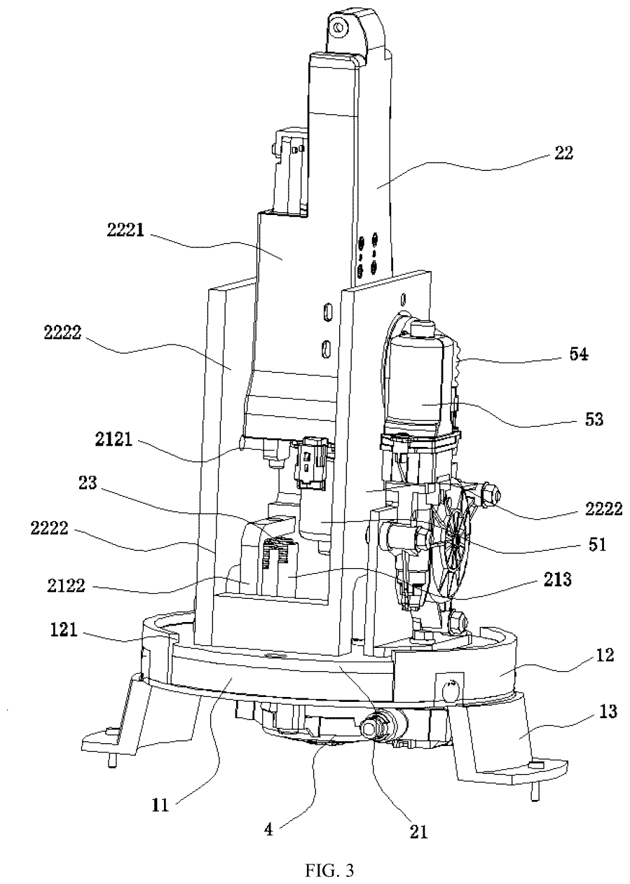

Referring to FIGS. 3, 8, and 9, the base 1 is provided with a first locking component 112 and a second locking component 113, and the rotating component 21 is provided with a third locking component 212. When the table board 3 is in the first position, the first locking component 112 can be connected with the third locking component 212 to limit the rotation of the rotating component 21. When the table board 3 is in the second position, the second locking component 113 can be connected with the third locking component 212 to limit the rotation of the rotating component 21. It can be understood that the foldable table board can be pushed by an external force during use, and the rotating component 21 is prone to relative movement with the base 1, resulting in position deviation of the table board 3, that is, the table board 3 is prone to position deviation. The first locking component 112 is arranged on the base 1, the third locking component 212 is arranged on the rotating component 21. When the table board 3 is in the first position, the first locking component 112 can be connected with the third locking component 212, thereby limiting the relative rotation between the rotating component 21 and the base 1, thus the table board 3 can be kept in the first position. Correspondingly, the second locking component 113 on the base 1 and the third locking component 212 on the rotating component 21 can keep the table board 3 in the second position, thus the use stability of the foldable table board can be improved, and the possibility of rotation of the table board 3 caused by external force collision during use can be reduced.

For example, the first locking component 112 and the second locking component 113 may be arranged on the first board 11.

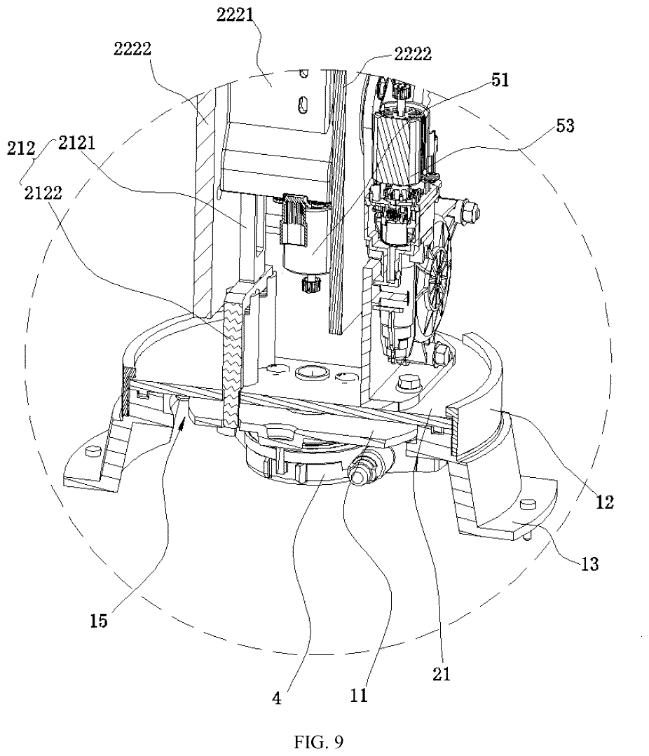

Referring to FIGS. 8 and 9, in some embodiments, the first locking component 112 and the second locking component 113 are locking holes defined in the base 1, and the third locking component 212 is a locking pin slidingly arranged on the rotating component 21. When the locking pin is in a locked state, the locking pin is inserted into the locking holes. When the locking pin is in an unlocked state, the locking pin is separated from the locking holes. The first locking component 112 and the second locking component 113 are constructed as locking holes, and the third locking component 212 is constructed as a locking pin, so that the structure of the three components can be simplified, and thus the machining difficulty of the rotating component 21 and the base 1 can be reduced. In addition, the rotating component 21 and the base 1 can be locked by moving the locking pin and adopting a plug-in cooperation mode, thereby the locking and unlocking between the rotating component 21 and the base 1 can be conveniently controlled.

For example, the first locking component 112 and the second locking component 113 may be locking holes defined in the first board 11.

In some other embodiments, the first locking component 112 and the second locking component 113 may adopt magnets. The third locking component 212 may adopt an electromagnet. Alternatively, the first locking component 112 and the second locking component 113 may adopt electromagnets, the third locking component 212 may adopt a magnet. Alternatively, the first locking component 112, the second locking component 113, and the third locking component 212 may adopt electromagnets. In these embodiments, the first locking component 112 and the second locking component 113 are locked with the third locking component 212 by magnetic attraction, and when unlocking is needed, the electromagnets may be powered off.

Referring to FIGS. 3 and 9 to 11, the locking pin includes a connecting component 2121 connected with the supporting assembly 2 and a fastening component 2122 for inserting into the locking holes. The connecting component 2121 is arranged on a side of the rotating component 21 away from the base 1, the rotating component 21 is provided with a through hole 215, and the fastening component 2122 can be inserted into the locking holes through the through hole 215. The connecting component 2121 is arranged on the side of the rotating component 21 away from the base 1, the connecting component 2121 does not occupy the space between the rotating component 21 and the base 1, so that the distance between the rotating component 21 and the base 1 can be reduced, thereby the base 1 can stably support the rotating component 21, that is, the support stability of the base 1 to the rotating component 21 is improved. The through hole 215 is arranged on the rotating component 21, and when the fastening component 2122 is simultaneously inserted into the through hole 215 and the locking holes, the rotating component 21 can be locked with the base 1, in this case, the rotating component 21 cannot rotate relative to the base 1, so that the table board 3 can be kept in the first position or the second position.

For example, the connecting component 2121 can be arranged on a side of the rotating component 21 away from the first board 11.

In some embodiments, the table board mechanism further includes a second driving mechanism 5 for driving the table board 3 to switch between the folded state and the unfolded state, the second driving mechanism 5 is connected with the table board 3 and the third locking component respectively, and when the second driving mechanism 5 drives the table board 3 to switch from the folded state to the unfolded state, the third locking component 212 is synchronously driven by the second driving mechanism 5 to move so that the third locking component 212 is connected with the first locking component 112 or the second locking component 113. The second driving mechanism 5 is provided to drive the table board 3 to switch from the folded state to the unfolded state and synchronously drive the fastening component 2122 to insert into the locking holes, the third locking component 212 can synchronously move in the process of rotating and unfolding the arm body 32, so that linkage of the two can be realized, and the locking pin can keep locking the rotating component 21 in the process of unfolding and using the table board mechanism. In addition, the drive force for switching the table board 3 between the folded state and the unfolded state and the drive force for moving the third locking component 212 are both from the second driving mechanism 5, and no additional driving mechanism is needed to drive the third locking component 212 to move, thus the number of driving mechanisms in the foldable table board can be saved, which is conducive to saving the space of the foldable table board, reducing the volume of the foldable table board, and reducing the occupation of the space in the vehicle.

In some embodiments, the second driving mechanism 5 may drive the arm body 32 to rotate about the fourth axis S4, so as to adjust the included angle between the arm body 32 and the supporting component 22, and drive the two board bodies 31 to rotate, so that the table board 3 can be switched between the folded state and the unfolded state.

In some embodiments, the third locking component 212 is a locking pin, the locking pin includes a connecting component 2121 connected with the supporting assembly 2 and a fastening component 2122 for being inserted into the locking holes. When the locking pin is in the unlocking state, the connecting component 2121 and the fastening component 2122 are spaced apart. When the locking pin is switched from the unlocking state to the locking state, the connecting component 2121 moves towards the fastening component 2122 and pushes the fastening component 2122 to be inserted into the locking holes. It can be understood that the foldable table board may be collided or pushed by an external force during use, and the direction of the external force is usually deviated from the first axis S1 (i.e. the rotation axis of the rotating component 21). Thus, the external force has a torsion effect, and the supporting component 22 is easily twisted. While as the locking pin for locking the rotating component 21 and the base 1, the locking pin is most likely to be broken when subjected to torsion. The connecting component 2121 and fastening component 2122 are spaced apart, i.e. the connecting component 2121 and the fastening component 2122 are provided as independent parts. Since the connecting component 2121 is connected with the supporting component 22, the connecting component 2121 is also subjected to the external force of collision or pushing during use of the foldable table board. However, the connecting component 2121 and the fastening component 2122 are in abutting relationship, even if the supporting component 22 is twisted, the connecting component 2121 and the fastening component 2122 can be dislocated, so that the torsion transmitted to the fastening component 2122 can be reduced, the possibility of breakage of the fastening component 2122 can be reduced, and the reliability of the locking pin can be improved.

For example, the connecting component 2121 can be driven by the second driving mechanism 5 to move towards the fastening component 2122, so that the connecting component 2121 abuts against the fastening component 2122 and pushes the fastening component 2122 to be inserted into the locking holes.

In this example, the fastening component 2122 of the locking pin may be connected with the rotating component 21, and the connecting component 2121 of the locking pin may be connected with the supporting component 22.

In other embodiments, the connecting component 2121 and the fastening component 2122 can be fixedly connected, i.e. the connecting component 2121 and the fastening component 2122 are connected as a whole. Alternatively, other structural arrangements may be employed to eliminate the influence of torsion on the fastening component 2122. For example, a spring may be arranged between the connecting component 2121 and the second driving mechanism 5, so that the connecting component 2121 may be displaced relative to the second driving mechanism 5.

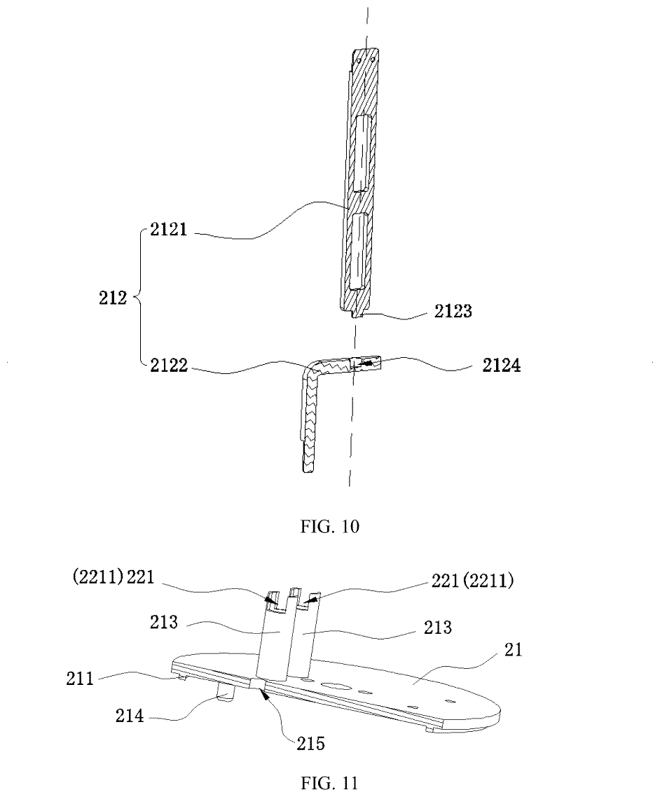

In some embodiments, one of the connecting component 2121 and the fastening component 2122 is provided with a locating member 2123, the other of the connecting component 2121 and the fastening component 2122 is provided with a locating hole 2124. When the connecting component 2121 abuts against the fastening component 2122, the locating member 2123 is inserted into the locating hole 2124. In this embodiment, referring to FIG. 10, the locating member 2123 is arranged on the connecting component 2121, and the locating hole 2124 is arranged on the fastening component 2122. In other embodiments, the locating member 2123 can be arranged on the fastening component 2122, and the locating hole 2124 can be arranged on the connecting component 2121. The locating member 2123 and the locating hole 2124 are arranged between the connecting component 2121 and the fastening component 2122, so that the locating member 2123 and the locating hole 2124 can be connected in a plug-in manner to improve the stability of the connection. In this embodiment, the locating hole 2124 is a blind hole, that is, the locating hole 2124 does not penetrate through the fastening component 2122, so that the influence on the strength of the fastening component 2122 can be reduced.

In some embodiments, the size of an end of the locating member 2123 can be smaller than the size of the root of the locating member 2123 (that is, when the connecting component 2121 and the fastening component 2122 are separated, the size of an end of the locating member 2123 close to the locating hole 2124 is smaller than the size of an end of the locating member 2123 away from the locating hole 2124). The opening of the locating hole 2124 is arranged in a trumpet shape, so that the locating member 2123 can be conveniently inserted into the locating hole 2124.

Referring to FIG. 9, the supporting assembly 2 is further provided with an elastic member 23. The elastic member 23 is connected with the fastening component 2122, so as to drive the fastening component 2122 to separate from the lock hole. When the table board 3 is switched from the unfolded state to the folded state, the fastening component 2122 can move to a side away from the lock hole under the elastic force of the elastic member 23, so as to separate from the lock hole to reset. Thus the locking on the rotating component 21 and the base 1 is released, and the rotating component 21 may rotate relative to the base 1 to realize the position adjustment of the table board 3. In some embodiments, the elastic member 23 can be a spring, a rubber pad, or the like.

For example, the connecting component 2121 is driven by the second driving mechanism 5, and when the second driving mechanism 5 drives the connecting component 2121 to move away from the fastening component 2122, the fastening component 2122 can separate from the lock hole to reset under the elastic force of the elastic member 23, so as to release the locking between the rotating component 21 and the base 1, thus the rotating component 21 can rotate relative to the base 1 to realize the position adjustment of the table board mechanism.

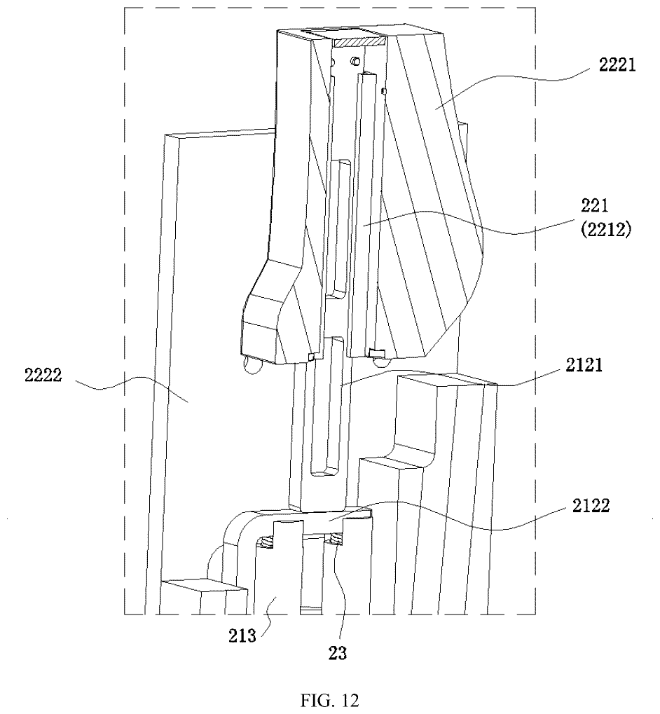

Referring to FIGS. 9 and 11, the supporting assembly 2 is provided with a guiding component 221. The guiding component 221 is connected with the lock pin and configured for guiding the movement of the lock pin. The guiding component 221 may guide the moving direction of the lock pin, so that the lock pin can move in a direction parallel to the first axis S1 shown in FIG. 1, and the lock pin can be inserted into the lock hole to realize the locking between the rotating component 21 and the base 1.

In some embodiments, the guiding component 221 is a second slot 2211 arranged on the rotating component 21. Referring to FIGS. 9 and 11, the rotating component 21 is provided with a mounting column 213 on a side surface away from the first board 11, and the second slot 2211 is a slot structure recessed from an end surface of the mounting column 213, and the fastening component 2122 of the locking pin is in sliding connection with the second slot 2211. The second slot 2211 is configured for guiding the movement of the fastening component 2122. The elastic member 23 may be arranged in the second slot 2211. For example, one end of the elastic member 23 may be connected with the fastening component 2122, and the other end of the elastic member 23 is connected with a side wall of the second slot 2211. For example, the fastening component 2122 may be L-shaped. In this way, the fastening component 2122 can be conveniently connected with the second slot 2211.

A plurality of second slots 2211, for example two, may be provided. Correspondingly, a plurality of the elastic member 23, for example two, may be provided. The locating hole 2124 on the fastening component 2122 can be located between the two second slots 2211. In this way, the stress of the fastening component 2122 can be balanced, and the jamming phenomenon during the movement of the fastening component 2122 can be reduced.

In some other embodiments, the guiding component 221 is a second slide rail 2212 arranged on the supporting component 22. Referring to FIG. 12, the connecting component 2121 of the locking pin is in sliding connection with the second slide rail 2212. In this way, the second slide rail 2212 is configured for guiding the movement of the connecting component 2121. The foldable table board may be provided with both the second slot 2211 and the second slide rail 2212.

The supporting component 22 includes a shell 222 connected with the rotating component 21. A part of the third locking component 212 is located in an enclosed area of the shell 222 and the rotating component 21. By arranging a part of the third locking component 212 in the enclosed area of the shell 222 and the rotating component 21, the shell 222 can protect the third locking component 212, thus accidental unlocking can be reduced. The accidental unlocking is occurred by a situation that the third locking component 212 is separated from the first locking component 112 or the second locking component 113 due to external collision with the third locking component 212 in the locked state.

For example, when the third locking component 212 is a locking pin, a part of the locking pin can be arranged in the enclosed area of the shell 222 and the rotating component 21. For example, the connecting component 2121 and a part of the fastening component 2122 of the locking pin may be arranged in the enclosed area of the shell 222 and the rotating component 21.

For example, the guiding component 221 may also be arranged in the shell 222. Exemplarily, when the guiding component 221 is the second slide rail 2212, the second slide rail 2212 may be integrally formed with the shell 222, or the second slide rail 2212 and the shell 222 may be two separate parts which are assembled by bonding or using fasteners.

Referring to FIGS. 3, 9 and 12, the shell 222 includes a shell cover 2221 and a plurality of shell boards 2222. The shell boards 2222 are fixed to the rotating component 21, the shell cover 2221 is arranged around the periphery of the supporting component 22, and the shell cover 2221 is rotatably connected with the shell boards 2222, so that the supporting component 22 can rotate around the fifth axis S5.

In some embodiments, the second driving mechanism 5 includes a second driving member 51 and a second transmission assembly. The second transmission assembly includes a screw rod 521 connected with an output shaft of the second driving member 51 and a moving block 522 slidingly arranged on the supporting assembly 2, the moving block 522 is in threaded connection with the screw rod 521, and the third locking component 212 is connected with the moving block 522. The screw rod 521 and the moving block 522 of the second transmission assembly can convert the rotary power provided by the second driving member 51 into the power for linear movement of the third locking component 212. When the second driving member 51 is started, the screw rod 521 rotates along with the output shaft of the second driving member 51, and the moving block 522 is connected with the third locking component 212, thereby driving the third locking component 212 to move linearly. In some embodiments, the second driving member 51 may be an electric motor, an engine or the like. A power output shaft of the second driving member 51 may rotate, and the second transmission assembly can convert the rotary motion into linear motion.

For example, the third locking component 212 is a locking pin, and the moving block 522 can be connected with a connecting component of the locking pin. When the second driving member 51 is started, the screw rod 521 rotates along with the output shaft of the second driving member 51, and the moving block 522 is connected with the connecting component 2121, and the connecting component 2121 is in sliding connection with the shell cover 2221. Thus, the rotary motion of the screw rod 521 can be converted into the linear motion of the moving block 522, thereby driving the connecting component 2121 to move up and down, and driving the locking pin to be inserted into the locking holes to lock the rotating component 21 and the first board 11.

In other embodiments, a rack and pinion structure may be configured to convert the rotary motion of the output shaft of the second driving member 51 into linear motion. For example, a pinion of the rack and pinion structure can be connected with the output shaft of the second driving member 51, and a rack of the rack and pinion structure can be connected with the connecting component 2121.

For example, in the embodiments of the present application, the second driving mechanism 5 may also drive the arm body 32 to rotate around the fifth axis S5. The second driving mechanism 5 further includes a third driving member 53 and a third transmission assembly, the third driving member 53 and the third transmission assembly can be mounted to a shell board 2222. The third driving member 53 may be an electric motor. The third transmission assembly includes a fourth gear (not shown in the figure) and a sector gear 54. The fourth gear is connected with an output shaft of the third driving member 53. The sector gear 54 is connected with the shell cover 2221. The power of the third driving member 53 is transmitted to the shell cover 2221 through the fourth gear and the sector gear 54, thereby driving the shell cover 2221 to drive the supporting component 22 to rotate around the fifth axis S5. The supporting component 22 and shell cover 2221 rotate as a whole.

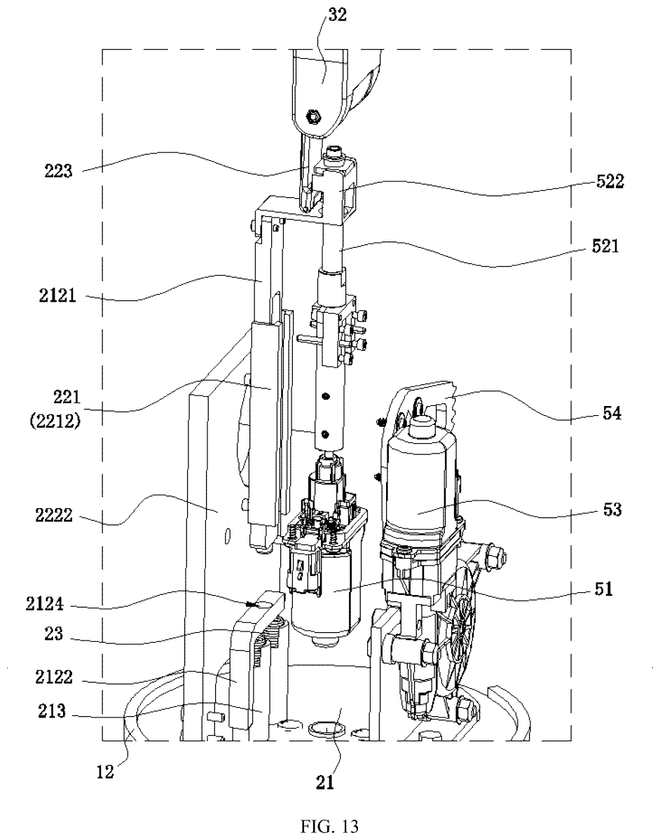

With reference to FIGS. 1 and 13, the moving block 522 is connected with the arm body 32 through a push board 223. The two ends of the push board 223 are hinged with the push board 223 and the arm body 32 respectively, and the arm body 32 is hinged with the shell 2221 of the supporting component 2. Thus the position of the push board 223 changes during the linear movement of the moving block 522, thereby driving the arm body 32 to rotate and realizing the unfolding and folding of the table board 3.

It should be noted that a plurality of driving members and transmission assemblies can be further arranged in the second driving mechanism 5 to drive the board body 31 of the table board 3 to rotate around the second axis S2 and drive the table board 3 to rotate around the third axis S3.

Referring to FIG. 6, one of the base 1 and the rotating component 21 is provided with a first slide rail 111, and the other of the base 1 and the rotating component 21 is provided with a sliding block 211. The first slide rail 111 is arranged around the rotation axis of the rotating component 21, and the rotating component 21 is rotated relative to the base 1 by sliding the sliding block 211 with the first slide rail 111. The first slide rail 111 shown in FIG. 6 is arranged on the base 1, and the sliding block 211 is arranged on the rotating component 21. In other embodiments, the sliding block 211 may be arranged on the base 1, and the first slide rail 111 may be arranged on the rotating component 21. A first guide rail 111 and a sliding block 211 slidably connected to each other are respectively arranged on the base member 1 and the rotation assembly 21. The cooperative use of the first guide rail 111 and the sliding block 211 is configured to guide relative movement between the rotating component 21 and the base 1, thereby reducing the possibility of deviation in the rotational direction of the rotating component 21, thus improve the stability of the foldable table board.

For example, the first slide rail 111 can be arranged on the first board 11 of the base 1.

In some embodiments, the sliding block 211 is annular-shaped. Thus, the first slide rail 111 may be in contact with the sliding block 211 at all positions, so that the rotation stability of the rotating component 21 is improved, and the stability of the foldable table board is improved.

In other embodiments, the sliding block 211 is one of a plurality of sliding blocks 211, and the plurality of sliding blocks 211 are arranged at intervals around the rotation axis of the rotating component 21. Thus, the frictional force generated by the first slide rail 111 and the sliding block 211 can be balanced by increasing the number of the sliding blocks 211, so that the rotation stability of the rotating component 21 is improved, and the stability of the foldable table board is improved.

With reference to FIG. 6, in some embodiments, the first slide rail 111 is arranged on the first board 11, and the first slide rail 111 is a first slot arranged in a recessed manner from the surface of the first board 11. The sliding block 211 is arranged on the rotating component 21, the sliding block 211 is a protruding block arranged in a protruding manner from the surface of the rotating component 21, and the protruding block is arranged in a sliding manner in the first slot. In other embodiments, the first slide rail 111 is arranged on the rotating component 21, the first slide rail 111 is a first slot arranged in a recessed manner from the surface of the rotating component 21. The sliding block 211 is arranged on the first board 11, the sliding block 211 is a protruding block arranged in a protruding manner from the surface of the first board 11, and the protruding block is arranged in a sliding manner in the first slot. The first slide rail 111 is constructed as a slot structure, and the sliding block 211 is constructed as a protrusion structure, so that the structures of the first slide rail 111 and the sliding block 211 can be simplified, thus the machining difficulty of the two can be reduced. In addition, the sliding assembly of the sliding block 211 and the first slide rail 111 can be realized by inserting the sliding block 211 into the first slide rail 111, thus the assembly difficulty of the two can be reduced, and the assembly efficiency of the foldable table board can be improved.

In some embodiments, the thickness of the peripheral portion of the first board 11 may be locally increased, so as to facilitate the forming of the first slot.

In some embodiments, the first slide rail 111 may be integrally formed with the first board 11, that is, the first slide rail 111 and the first board 11 have no splicing or assembly traces. Thus the connection stability of the first slide rail 111 and the first board 11 can be improved. The sliding block 211 can be integrally formed with the rotating component 21, that is, the sliding block 211 and the rotating component 21 have no splicing or assembly traces. Thus the connection stability of the sliding block 211 and the rotating component 21 can be improved.

Referring to FIGS. 6 to 9, the base 1 is provided with an annular surrounding wall 12, the annular surrounding wall 12 is arranged around the edge of the rotating component 21. The annular surrounding wall 12 is arranged on the base 1, and the rotating component 21 is arranged in the enclosed region of the annular surrounding wall 12, so that the annular surrounding wall 12 can play a protective role on the rotating component 21, and the probability of abrasion caused by other parts in the environment abutting against the rotating component 21 can be reduced.

For example, the annular surrounding wall 12 can be arranged on the first board 11 of the base 1.

The inner side wall of the annular surrounding wall 12 is provided with a fourth limit component 121, the fourth limit component 121 is configured for abutting against a side of the rotating component 21 away from the base 1. In this way, the fourth limit component 121 can limit a relative distance between the rotating component 21 and the base 1, and the fourth limit component 121 can provide a limit to the rotating component 21 in the direction parallel to the first axis S1, so as to limit the rotating component 21 from moving toward a side away from the base 1, thereby reducing the risk of the rotating component 21 being separated from the base 1. In addition, if the rotating component 21 bounces during rotation, the fourth limit component 121 may abut against the rotating component 21, so that the rotating component 21 can rotate smoothly, thereby improving the rotation stability of the table board mechanism.

In some embodiments, the side of the first board 11 away from the rotating component 21 may be further provided with a second board 13, and the second board 13 can be fixed to an external device by a fastener such as a screw, so as to achieve mounting of the foldable table board and the external device.

It should be noted that the foldable table board in any of the above embodiments may be applied not only in an automobile but also in a vehicle such as an airplane, a ship, or etc. The foldable table board is not limited to being mounted to a seat, but can be mounted at any position. The foldable table board in any of the above embodiments may also be applied in the field of a furniture, for example, the foldable table board can be used in a residential area, an office building, a shopping mall, or the like. The foldable table board in any of the above embodiments can also be applied in an outdoor scene. And the application field and the mounting position of the foldable table board are not limited in the embodiments of the application.

It should be noted that the base 1 may be provided with a controller (not shown in the figures), and two opening buttons (not shown in the figures) can be respectively arranged on two sides of the base 1. The opening buttons are connected with the controller, the controller can be connected with all the driving members of the foldable table board. A user can press any one of the opening buttons. The controller can determine the position of the user according to information that the user presses the opening button, and then control the opening and closing of the first driving member 41, so that the table board 3 can be located on the side where the user is after the table board 3 is unfolded. For example, when the user is located on the left side of the foldable table board, and the user presses the opening button on the left side of the foldable table board, thereby the opening button on the left side may send information to the controller, and the controller can determine that the user is located on the left side of the foldable table board according to the information. Thus in the process of unfolding the table board mechanism, the unfolded table board 3 may be located on the side where the user is by adjusting the starting and closing of the first driving member 41. When the user changes the position to the right side of the foldable table board, the user can press the opening button on the right side of the foldable table board, thus the controller can start the second driving member 51 and the first driving member 41 in sequence, so that the locking pin unlocks the rotating component 21 and the first board 11, and then the rotating component 21 rotates 180° relative to the first board 11, so that the position of the table board 3 is switched.

The two sides of the base 1 may also be respectively provided with two closing buttons (not shown in the figures), the closing buttons can be connected with all the driving members of the foldable table board. When the user presses one of the closing buttons, the controller starts the driving members of the foldable table board, so that the table board mechanism is driven to be folded and stored.

A possible implementation manner of the foldable table board is as follows:
the foldable table board includes a table board mechanism, a base 1 and a first driving mechanism 4. The table board mechanism includes a supporting assembly 2 and a table board 3 arranged on the supporting assembly 2. The supporting assembly 2 includes a rotating component 21 and a supporting component 22. The table board 3 includes two board bodies 31 hinged to each other. The base 1 includes a first board 11, an annular surrounding wall 12 arranged on the first board 11, and a second board 13. The center of the rotating component 21 is rotatably connected with the center of the first board 11 through a connecting shaft 14. The annular surrounding wall 12 is arranged around the periphery of the rotating component 21. The inner side wall of the annular surrounding wall 12 is provided with a fourth limit component 121, the fourth limit component 121 is configured for abutting against the side surface of the rotating component 21 away from the first board 11, so that the rotating component 21 is located between the first board 11 and the fourth limit component 121. The first driving mechanism 4 includes a first driving part 41 and a first transmission assembly. The first driving part 41 is a motor, and the first transmission assembly includes a worm gear 423 and a worm (not shown in the figure) meshed with the worm gear 423. The worm is connected with the output shaft of the first driving part 41, the worm gear 423 is arranged on the side of the first board 11 away from the rotating component 21. The worm gear 423 is connected with the rotating component 21 through a first connecting component 16. The first board 11 is provided with a first avoiding hole 114 for avoiding the first connecting component 16. The first board 11 is provided with a first slide rail 111, the first slide rail 111 is a first slot recessed from the surface of the first board 11. The rotating component 21 is provided with a sliding block 211, the sliding block 211 is a protruding block arranged in a protruding manner from the surface of the rotating component 21. The sliding block 211 is slidingly arranged in the first slide rail 111, the first slide rail 111 is annular, the sliding block 211 is also annular, the first slide rail 111 is integrally formed with the first board 11, and the sliding block 211 is integrally formed with the rotating component 21. The first board 11 is provided with a limit groove 15, the side surfaces of the two ends of the limit groove 15 along the length direction are respectively a first limit component 151 and a second limit component 152, the central angle of the annular limit groove 15 is set to 180°. The rotating component 21 is provided with a third limit component 214. When the table board 3 is in a first position, the third limit component 214 abuts against the first limit component 151. When the table board 3 is in a second position, the third limit component 214 abuts against the second limit component 152. The first locking component 112 and the second locking component 113 are two locking holes defined in the first board 11. The third locking component 212 is a locking pin arranged on the rotating component 21, the locking pin includes a connecting component 2121 connected with the supporting assembly 2 and a fastening component 2122 configured for being inserted into the locking holes. The connecting component 2121 is arranged on the side of the rotating component 21 away from the first board 11, the rotating component 21 is provided with a through hole 215, the fastening component 2122 may be inserted into one of the locking holes through the through hole 215. When the table board 3 is in the first position, the fastening component 2122 of the locking pin can be inserted into one of the locking holes through the through hole 215 to limit the rotation of the rotating component 21. When the table board 3 is in the second position, the fastening component 2122 of the locking pin may be inserted into the other of the locking holes through the through hole 215 to limit the rotation of the rotating component 21. The connecting component 2121 and the fastening component 2122 are spaced apart. The second driving mechanism 5 drives the connecting component 2121 to move towards the fastening component 2122. The connecting component 2121 is provided with a locating member 2123, and the fastening component 2122 is provided with a locating hole 2124. The rotating component 21 is provided with a mounting column 213 on a side surface away from the first board 11, the mounting column 213 is recessed from an end surface to form a second slot 2211. The fastening component 2122 is slidingly arranged in the second slot 2211. A spring is further arranged in the second slot 2211, and two ends of the spring are connected with the fastening component 2122 and a side wall of the second slot 2211 respectively. The spring can drive the fastening component 2122 to separate from the locking holes when the locking pin is switched from the locking state to the unlocking state. The table board 3 includes two board bodies 31 rotatably connected with each other and an arm body 32 connecting the two board bodies 31 with the supporting component 22. The table board mechanism further includes a second driving mechanism 5 for driving the table board 3 to switch between the folded state and the unfolded state. The second driving mechanism 5 includes a second driving member 51 and a second transmission assembly. The second driving member 51 is arranged on the supporting component 22. The second driving member 51 is a motor. The second transmission assembly includes a screw rod 521 and a moving block 522 in threaded connection with the screw rod 521. The screw rod 521 is connected with an output shaft of the second driving member 51. The moving block 522 is connected with the connecting component 2121 and one end of a push board 223 respectively. The other end of the push board 223 is hinged with the arm body 32. The second driving member 51 drives the arm body 32 to rotate and drives the connecting component 2121 to move when starting, so that the position of the arm body 32 and the connecting component 2121 synchronously change. The supporting component 22 includes a shell 222, the shell 222 includes a shell cover 2221 and a plurality of shell boards 2222. The shell boards 2222 are fixed with the rotating component 21, the shell cover 2221 is hinged with the shell boards 2222. The second transmission assembly is located in the shell cover 2221, a second slide rail is also arranged in the shell cover 2221. The connecting component 2121 is slidingly arranged on the second slide rail. A third driving member 53 and a third transmission assembly are further arranged on the shell boards 2222. The third driving member 53 may be a motor, and the third transmission assembly includes a fourth gear and a sector gear 54. The fourth gear is connected with an output shaft of the third driving member 53, and the sector gear 54 is connected with the shell cover 2221. Power of the third driving member 53 is transmitted to the shell cover 2221 through the fourth gear and the sector gear 54, so as to drive the shell cover 2221 to drive the supporting component 22 to rotate around the fifth axis S5. The supporting component 22 and shell cover 2221 rotate as a whole. A plurality of driving members and transmission assemblies can be further arranged in the foldable table board, so as to drive the board body 31 of the table board 3 to rotate around the second axis S2 and drive the table board 3 to rotate around the third axis S3.

The embodiment of the application also provides a furniture, which includes a first body component (not shown in the figures) and the foldable table board in any of the above embodiments. A first accommodating cavity is arranged in the first body component. The foldable table board has a base 1 connected with the first body component. The table board mechanism can be folded and accommodated in the first accommodating cavity. Since the foldable table board is small in volume and occupies small space, the furniture including the foldable table board can reduce the size and the space occupation.

It should be noted that the furniture can be a seat sofa, a bedside table or a floor lamp, or etc. When the furniture is the seat sofa, the first body component may be a backrest, a stool, or an armrest of the seat sofa. When the furniture is the bedside table, the first body component may be a cabinet body of the bedside table. When the furniture is the floor lamp, the first body component can be a lamp base.

It should be noted that the application scenarios of the furniture can be home scenarios, office scenarios or outdoor scenarios.

The embodiment of the application also provides a vehicle, including a second body component (not shown in the figures) and the foldable table board in the above embodiments. A second accommodating cavity is arranged in the second body component. The base 1 of the foldable table board is connected with the second body component. The table board mechanism may be folded and accommodated in the second accommodating cavity. Since the foldable table board is small in volume and occupies small space, the vehicle including the foldable table board can reduce the size and the space occupation, so that the internal space of the vehicle is wider.

It should be noted that the vehicle in the embodiments of the application may be an automobile, a ship, an airplane, a train or the like.

For example, the second body component may be a seat in the vehicle. The base 1 of the foldable table board is connected with the seat, the second accommodating cavity may be arranged in an armrest box of the seat, and the foldable table board may be accommodated in the second accommodating cavity of the armrest box of the seat.

The above only describes the preferred embodiments of the application and is not used to limit the application. Any modification, equivalent replacement and improvement made within the spirit and principle of the application should be included in the protection scope of the application.

1. A foldable table board, comprising:
a table board mechanism, comprising a supporting assembly (2) and a table board (3) arranged on the supporting assembly (2), wherein the table board (3) is movably connected to the supporting assembly (2), so that the table board (3) is switched between a folded state and an unfolded state relative to the supporting assembly (2);
a base (1) for carrying the table board mechanism, wherein the supporting assembly (2) is rotatably connected to the base (1), so that the table board (3) can rotate between a first position and a second position relative to the base (1).

2. The foldable table board of claim 1, further comprising:
a first driving mechanism (4) mounted to the base (1); wherein
the first driving mechanism (4) is drivingly connected to the supporting assembly (2) to drive the supporting assembly (2) to rotate relative to the base (1), thereby driving the table board (3) to rotate to the first position or the second position.

3. The foldable table board of claim 2, wherein the first driving mechanism (4) comprises:
a first driving member (41), and a first transmission assembly connected with the first driving member (41); wherein
one of the first driving member (41) and the first transmission assembly is mounted to the base (1), the other of the first driving member (41) and the first transmission assembly is connected with the supporting assembly (2), and the first transmission assembly is configured for adjusting a rotating speed of the supporting assembly (2) relative to the base (1).

4. The foldable table board of claim 3,
wherein the first transmission assembly comprises a worm gear (423) and a worm engaged and connected with the worm gear (423), wherein the worm is connected with an output shaft of the first driving member (41), and the worm gear (423) being connected with the supporting assembly (2);
or, wherein the first transmission assembly comprises a first gear (421) and an internal gear (422), wherein the first gear (421) is engaged with gear teeth arranged on an inner peripheral side surface of the internal gear (422), the first gear (421) is connected with an output shaft of the first driving member (41), and the internal gear (422) is connected with the base (1);
or, wherein the first transmission assembly comprises a second gear and a third gear, wherein the second gear is engaged with gear teeth arranged on an outer peripheral side surface of the third gear, the second gear is connected with an output shaft of the first driving member (41), and the third gear is connected with the supporting assembly (2).

5. The foldable table board according to claim 1, wherein the supporting assembly (2) comprises:
a rotating component (21) rotatably mounted to the base (1), and a supporting component (22) arranged on the rotating component (21); wherein
the table board (3) is arranged on the supporting component (22), and the rotating component (21) is capable of rotating relative to the base (1) to drive the supporting component (22) to rotate, so that the table board (3) rotates between the first position and the second position.

6. The foldable table board according to claim 5, wherein
the base (1) is provided with a first limit component (151) and a second limit component (152), and the rotating component (21) is provided with a third limit component (214); and
when the table board (3) is in the first position, the third limit component (214) abuts against the first limit component (151), and when the table board (3) is in the second position, the third limit component (214) abuts against the second limit component (152).

7. The foldable table board according to claim 6, wherein the base (1) is provided with a limit groove (15), the limit groove (15) is arranged around a rotation axis of the rotating component (21), the third limit component (214) is slidingly arranged in the limit groove (15), and inner side walls at two ends of the limit groove (15) in a length direction respectively form the first limit component (151) and the second limit component (152).

8. The foldable table board according to claim 5, wherein:
the base (1) is provided with a first locking component (112) and a second locking component (113), and the rotating component (21) is provided with a third locking component (212);
when the table board (3) is in the first position, the first locking component (112) is capable of being connected with the third locking component (212) to limit the rotation of the rotating component (21); and
when the table board (3) is in the second position, the second locking component (113) is capable of being connected with the third locking component (212) to limit the rotation of the rotating component (21).

9. The foldable table board according to claim 8, wherein the table board mechanism further comprises:
a second driving mechanism (5) for driving the table board (3) to switch between the folded state, and the unfolded state; wherein
the second driving mechanism (5) is connected with the table board (3) and the third locking component (212) respectively, and when the second driving mechanism (5) drives the table board (3) to switch from the folded state to the unfolded state, the third locking component (212) is synchronously driven by the second driving mechanism (5) to move so that the third locking component (212) is connected with the first locking component (112) or the second locking component (113).

10. The foldable table board of claim 8, wherein:
the first locking component (112) and the second locking component (113) are locking holes defined in the base (1);
the third locking component (212) is a locking pin slidingly arranged on the rotating component (21);
when the locking pin is in an unlocking state, the locking pin is inserted into one of the locking holes; and
when the locking pin is in a locking state, the locking pin is separated from the locking holes.

11. The foldable table board of claim 10, wherein the locking pin comprises:
a connecting component (2121) connected with the supporting assembly (2), and a fastening component (2122) for inserting into the locking holes; wherein
the connecting component (2121) is arranged on a side of the rotating component (21) away from the base (1), the rotating component (21) is provided with a through hole (215), and the fastening component (2122) is capable of being inserted into the locking holes through the through hole (215).

12. The foldable table board of claim 11, wherein the connecting component (2121) and the fastening component (2122) are spaced apart when the locking pin is in the unlocking state, and the connecting component (2121) moves towards the fastening component (2122) and pushes the fastening component (2122) to be inserted into the locking holes when the locking pin is switched from the unlocking state to the locking state.

13. The foldable table board of claim 12, wherein one of the connecting component (2121) and the fastening component (2122) is provided with a locating member (2123), the other of the connecting component (2121) and the fastening component (2122) is provided with a locating hole (2124), and the locating member (2123) is inserted into the locating hole (2124) when the connecting component (2121) abuts against the fastening component (2122).

14. The foldable table board of claim 12, wherein the supporting assembly (2) is further provided with an elastic member (23); wherein
the elastic member (23) is connected with the fastening component (2122) and the rotating component (21) respectively, and the elastic member (23) drives the fastening component (2122) to be separated from the locking holes when the locking pin is switched from the locking state to the unlocking state.

15. The foldable table board of claim 10, wherein the supporting assembly (2) is further provided with a guiding component (221), and the guiding component (221) is connected with the locking pin and configured for guiding the movement of the locking pin.

16. The foldable table board according to claim 9, wherein the second driving mechanism (5) comprises a second driving member (51), and a second transmission assembly; wherein
the second transmission assembly comprising a screw rod (521) connected with an output shaft of the second driving member (51) and a moving block (522) slidingly arranged on the supporting assembly (2), the moving block (522) is in threaded connection with the screw rod (521), and the third locking component (212) is connected with the moving block (522).

17. The foldable table board according to claim 8, wherein the supporting component (22) comprises a shell (222) connected with the rotating component (21), and a part of the third locking component (212) is located in an enclosed area of the shell (222) and the rotating component (21).

18. The foldable table board according to claim 5, wherein one of the base (1) and the rotating component (21) is provided with a first slide rail (111), the other of the base (1) and the rotating component (21) is provided with a sliding block (211), the first slide rail (111) is arranged around a rotation axis of the rotating component (21), and the rotating component (21) is rotated relative to the base (1) by means of the sliding block (211) slidably engaged with the first slide rail (111).

19. The foldable table board according to claim 18, wherein:
the sliding block (211) is annular; or
the sliding block (211) is one of a plurality of sliding blocks (211), and the plurality of the sliding blocks (211) are arranged at intervals around the rotation axis of the rotating component (21).

20. The foldable table board according to claim 5, wherein the base (1) is provided with an annular surrounding wall (12), and the annular surrounding wall (12) is arranged around an edge of the rotating component (21).

21. The foldable table board according to claim 20, wherein an inner side wall of the annular surrounding wall (12) is provided with a fourth limit component (121), and the fourth limit component (121) is configured for abutting against a side of the rotating component (21) away from the base (1).

22. A furniture, comprising a first body component, and further comprising the foldable table board according to claim 1, wherein a first accommodating cavity is arranged in the first body component, the base (1) of the foldable table board is connected with the first body component, and the table board mechanism is fold and accommodated in the first accommodating cavity.

23. A vehicle, comprising a second body component, and further comprising the foldable table board according to claim 1, wherein a second accommodating cavity is arranged in the second body component, the base (1) of the foldable table board is connected with the second body component, and the table board mechanism is fold and accommodated in the second accommodating cavity.
